(19) United States
(12) Patent Application Publication
(10) Pub. No.: US 2012/0189297 A1
(43) Pub. Date: Jul. 26, 2012

(54) Viewfinder

(76) Inventors: Richard E. Feinbloom, New York, NY (US); David B. Soll, Ambler, PA (US)

(21) Appl. No.: 13/358,456

(22) Filed: Jan. 25, 2012

Related U.S. Application Data
(63) Continuation-in-part of application No. 12/927,895, filed on Nov. 29, 2010.

(51) Int. Cl. G03B 13/04

(52) U.S. Cl. 396/544

(57) ABSTRACT

A viewfinder including a base member for removably mounting on an electronic device suitable for taking digital photographs, and an open-ended housing disposed substantially perpendicular to, and offset from the base member is disclosed. The housing includes a sighting grid disposed adjacent an open end of the open-ended housing.

### CLAIM OF PRIORITY

This application claims, pursuant to 35 USC §120, as a Continuation-in-Part, priority to and the benefit of the earlier filing date of, that patent application entitled Viewfinder, filed in the US Patent Office on Nov. 10, 2010 and afforded Ser. No. 12/927,895, the contents of which is incorporated by reference herein.

### BACKGROUND

1. Field of the Invention

The invention relates generally to viewfinders, and more particularly, to viewfinders for electronic devices suited for taking digital photographs.

2. Background of the Invention

Digital photography is popular worldwide, yet many digital compact cameras do not have viewfinders. Viewfinders are used to compose and frame a scene. When present, the viewfinder on a digital camera may be either an optical viewfinder that works through the lens, or an electronic viewfinder, which is a small LCD, both of which are formed as an integral part of the camera. Optical viewfinders have disadvantages, however, since the viewfinder shows only about 70-75% of what the camera lens actually “sees”. The electronic viewfinder also has disadvantages, as it may not be as clear as an optical viewfinder, but it does show the entire area to be photographed. In view of the problems associated with viewfinders, it is becoming increasingly difficult to find a commercially-available digital camera with a viewfinder.

When no viewfinder is present on a camera, many use the LCD screen to frame a shot for a photograph. Cellular telephones also have an LCD (or LED or OLED), screen which may be used to frame a scene. Digital cameras or cellular telephones that have only an LCD screen and no viewfinder may cause the photographer using the device to hold it approximately 18 inches or at arm's length from the eyes so the image is visible on the LCD screen, but the photographer can only estimate the focus and composition of the image at this distance. Viewing the LCD screen can be difficult also in brightly-lighted and sunlit areas, as there can be significant glare on the viewing screen, leaving the photographer with the need to use a hand or other device to shade the LCD screen.

Thus, there remains a need for viewfinders for electronic devices suited for taking digital photographs.

### BRIEF DESCRIPTION OF THE DRAWINGS

FIG. 1 is an elevational view of the device according to an aspect of the invention;

FIG. 2 is a side view of the device according to an aspect of the invention;

FIG. 3 is a side view of the device disposed on an electronic device;

FIG. 4 is a back view of the device disposed on an electronic device;

FIG. 4A illustrates a side view of a viewfinder in accordance with a second embodiment of the invention;

FIG. 4B illustrates a side view of a viewfinder in accordance with a second embodiment of the invention disposed on an electronic device;

FIG. 4C illustrates a side view of a viewfinder in accordance with a third embodiment of the invention claimed, disposed on an electronic device;

FIG. 4D illustrates a front view of a viewfinder shown in FIG. 4C;

FIG. 4E illustrates a back view of a viewfinder shown in FIG. 4C;

FIG. 5 illustrates a front view of a viewfinder in accordance with a another embodiment of the invention;

FIG. 6 illustrates a side view of the viewfinder shown in FIG. 5;

FIG. 7 illustrates a prospective view of the viewfinder shown in FIG. 5;

FIG. 8 illustrates a second side view of the viewfinder shown in FIG. 5;

FIG. 9 illustrates a prospective view of the viewfinder shown in FIG. 5;

FIG. 10 illustrates a front view an embodiment of the viewfinder in accordance with a still another embodiment of the invention;

FIG. 11 illustrates a prospective view of the viewfinder shown in FIG. 10;

FIG. 12 illustrates a second prospective view of the viewfinder shown in FIG. 10;

FIG. 13 illustrates a side view of the viewfinder shown in FIG. 10; and

FIG. 14 illustrates a second side view of the viewfinder shown in FIG. 10.

FIG. 15 illustrates a prospective view of another exemplary embodiment of the viewfinder in accordance with the principles of the invention.

FIG. 16 illustrates a second prospective view of the embodiment of the viewfinder shown in FIG. 15.

FIG. 17 illustrates a side view of the embodiment of the viewfinder shown in FIG. 15.

FIG. 18 illustrates a prospective view of another exemplary embodiment of the viewfinder in accordance with the principles of the invention.

FIG. 19 illustrates a second prospective view of the exemplary embodiment of the viewfinder shown in FIG. 18.

FIG. 20 illustrates a side view of the exemplary embodiment of the viewfinder shown in FIG. 18.

### SUMMARY OF THE INVENTION

According to an aspect of the invention, a viewfinder including a base member for removably mounting on an electronic device suitable for taking digital photographs, attachment means connected to the base member for coupling the base member to an electronic device, an open-ended housing disposed on the base member, and a sighting grid disposed adjacent an open end of the open-ended housing is disclosed.

According to another aspect of the invention, a viewfinder for removably mounting onto an electronic device suitable for taking digital photographs includes a substantially rectangular base member, including a substantially planar top surface and a substantially planar bottom surface, a first end including a first downwardly extending rod supporting member, a second end including a second downwardly extending rod supporting member, and two rods disposed adjacent the substantially planar bottom surface and extending from the first end to the second end of the base member; a downwardly extending sliding member disposed between the first end and the second end and slidably coupled to said substantially rectangular base member by the two rods; a housing disposed on the top planar surface of the base member, the housing including a sighting grid is also disclosed.

According to another aspect of the invention, a method for using a removably mounted viewfinder on an electronic device includes disposing a viewfinder on an electronic device suitable for taking digital photographs, the viewfinder including a base member for removably mounting on an electronic device, a sliding member slidably connected to the base member, an open-ended housing disposed on the base member, and a sighting grid disposed adjacent an open end of the open-ended housing; viewing an image through the sighting grid; and capturing the image by taking a photograph using the electronic device is also disclosed.

According to another embodiment of the invention, the viewfinder includes a housing that is positioned on a stem that extends substantially perpendicular to a mounting means. The housing may be oriented substantially parallel to or oriented at an angle with respect to the mounting means. The housing may be fixedly attached to the stem at a fixed angle or may be rotational about a rotational means in order to orient the housing at a desired angle. The mounting means is represented as a plate that may be attached to a camera body by an attachment means. The mounting means may include a slot or a plurality of holes through which the attachment means may be inserted and attached to the camera body. The camera body typically includes an internal screw attachment that allows a screw-type attachment means to attach the mounting means to the camera body.

### DETAILED DESCRIPTION

As used herein, the terms “comprises”, “comprising”, “includes”, “including”, “has”, “having”, or any other variation thereof, are intended to cover non-exclusive inclusions. For example, a process, method, article or apparatus that comprises a list of elements is not necessarily limited to only those elements but may include other elements not expressly listed or inherent to such process, method, article, or apparatus. In addition, unless expressly stated to the contrary, the term “of” refers to an inclusive “or” and not to an exclusive “or”. For example, a condition A or B is satisfied by any one of the following: A is true (or present) and B is false (or not present); A is false (or not present) and B is true (or present); and both A and B are true (or present).

The terms “a” or “an” as used herein are to describe elements and components of the invention. This is done for convenience to the reader and to provide a general sense of the invention. The use of these terms in the description herein should be read and understood to include one or at least one. In addition, the singular also includes the plural unless indicated to the contrary. As used in this specification and the appended claims, the term “or” is generally employed in its sense including “and/or” unless the content clearly dictates otherwise.

All numeric values are herein assumed to be modified by the term “about,” whether or not explicitly indicated. The term “about” generally refers to a range of numbers that one of skill in the art would consider equivalent to the recited value (i.e., having the same function or result). In all instances, the terms “about” may include numbers that are rounded to the nearest significant figure.

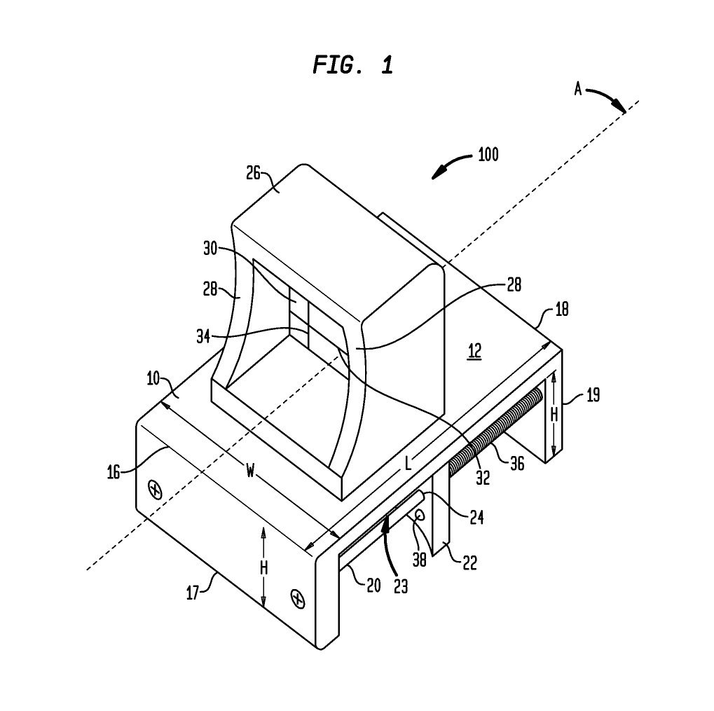

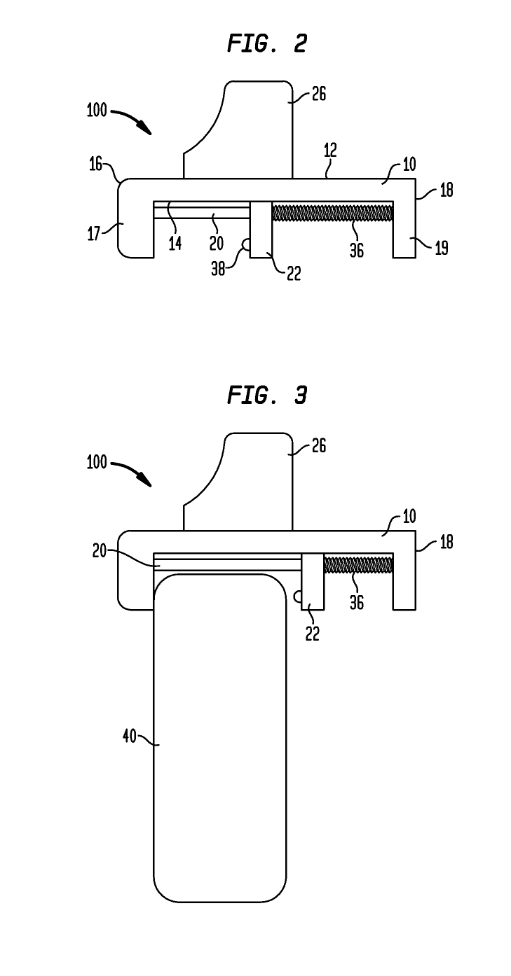

Referring to FIG. 1, according to an aspect of the invention, a viewfinder 100 including a base member 10 for removably mounting on an electronic device is illustrated. The base member 10 includes a top surface 12 and a bottom surface 14 (FIG. 2), both of which may be substantially planar. Base member 10 also includes a first end 16 and a second end 18. The first end 16 and second end 18 each include rod support members 17 and 19, respectively. Rod support members 17 and 19 extend downwardly from the first end 16 and second end 18, respectively. According to an aspect of the invention, the second rod support member 19 may be shorter in height than the first rod support member 17.

One or more rods 20 are coupled to the base member 10 by a suitable attachment device, depicted in FIG. 1 as screws. Other alternative and conventional means for attachment of the rods 20 may also be used. The rods 20 may be formed of a suitable material, for example, metal or rigid plastic. As illustrated in FIG. 2, the rods 20 are disposed adjacent the bottom surface 14 of the viewfinder 100.

Referring to FIG. 1, a spring-like wire 36 is disposed about each of the one or more rods 20. The spring-like wire 36 is disposed along a length of a rod between the second rod support member 19 and the sliding member 22.

Referring to FIG. 1, coupled to the base member 10 is a sliding member 22. The sliding member 22 includes one or more apertures 24 extending from one side of the member 22 to the opposite side, for receiving one or more rods 20. The rods 20 also provide for the slidable coupling of the sliding member 22 to the base member 10. The sliding member 22 as illustrated in FIG. 1 is disposed on the viewfinder 100 between the rod support members 17 and 19. A first rod 20 is illustrated as extending through a corresponding aperture 24 in the sliding member 22. A second rod 20 in parallel with the first rod 20 is also present on the viewfinder 100, although one centrally-located rod 20 may be suitable for use according to an aspect of the invention.

The sliding member 22 may further include one or more stops 38. Stops 38 may be substantially hemi-spherical in shape, although other configurations are envisioned. For example, the stops may be square rubber pads, or formed of other suitable material, including rigid or semi-rigid foam. As illustrated, the stops 38 are disposed adjacent the bottom of the sliding member 22 on the side facing the first end 16 and rod support member 17.

Sliding member 22 also may include a cutaway portion 23 to provide ease in grasping and moving the sliding member 22. It should be understood that although the cutaway portion 23 as illustrated is arc-shaped, any suitable geometric shape may be used.

Referring still to FIG. 1, disposed on the top surface 12 of the base member is a housing 26. The housing 26 is open at both ends, and is substantially rectangular. At one open end of the housing 26 there are slightly curved portions 28, and at the opposite, open end of the housing 26 a sighting grid 30 is disposed.

The sighting grid 30 may include one or more horizontal lines 32 intersecting with one or more vertical lines 34. The sighting grid 30 may be used to center a subject or to use as a guide in reducing parallax error, as herein described. Although the sighting grid 30 is described as including one or more horizontal lines intersecting with one or more vertical lines, it should be understood that different orientations for the sighting grid 30 are possible. For example, the lines may intersect to form triangles, parallelograms, and other geometrical shapes. The horizontal lines 32 and vertical lines 34 may be formed from a steel, a nylon or similar material that may be held taut within the housing 26. In addition, the viewfinder may be a conventional lens type viewfinder without altering the scope of the invention.

The base member 10 and the housing 26 may be formed of a rigid plastic material, to provide sufficient rigidity to the viewfinder 100 and to maintain the integrity of the viewfinder 100 on an electronic device. The rigid plastic may be molded. Suitable materials include, but are not limited to: polyethylene, polypropylene, silicon and polycarbonate. Although a rigid plastic is described, other suitable, lightweight materials may also be employed.

Suitable dimensions for base member 10 of the viewfinder include, but are not limited to: from about 1¾ to about 2 inches in length, and about 1½ to about 1¾ inches in width. The dimensions of the housing 26 are from about ¾ inch at the interface of the housing 26 with the top surface 12 of the base member 10, and about ½ inch at the opposite end thereof. The height of the housing is about ¾ inch to about 1 inch. It should be understood that the dimensions of the device are not critical, and may be modified to accommodate the different widths and shapes of electronic devices.

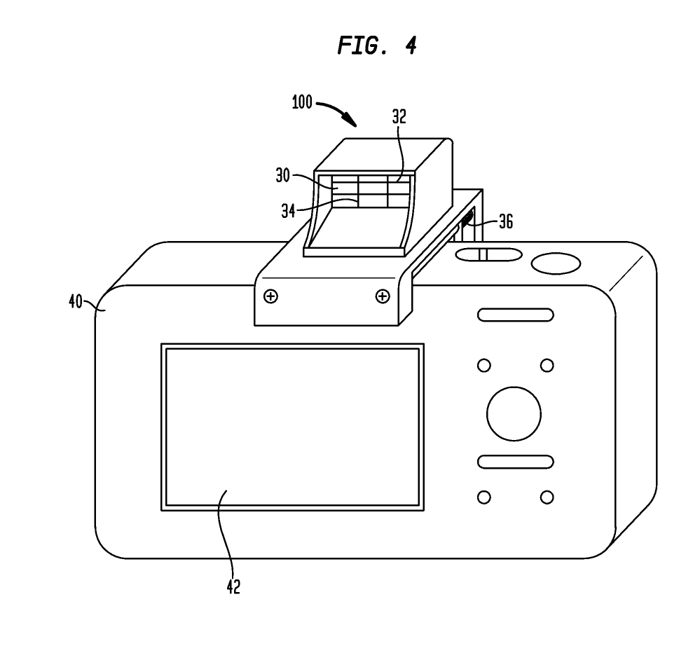

Referring to FIGS. 2 and 3, the movement of the sliding member 22 and mounting of the viewfinder 100 on an electronic device 40 is illustrated. In FIG. 2, a side view of the sliding member 22 is illustrated. To mount the viewfinder 100 on an electronic device 40, the sliding member 22 is pushed or pulled along the one or more rods 20 toward the second end 18 of the base member 10, which compresses the spring-like wire 36. When the sliding member 22 is moved a sufficient distance to receive an electronic device 40, the sliding member 22 is released, and the spring-like wire 36 helps maintain the viewfinder 100 in place. When present, the stops 38 also help maintain the viewfinder 100 on the device 40. The viewfinder 100 is easily removed by moving the sliding member 22 toward the second end 18 of the base member 10, and removing the viewfinder 100 from the device 40.

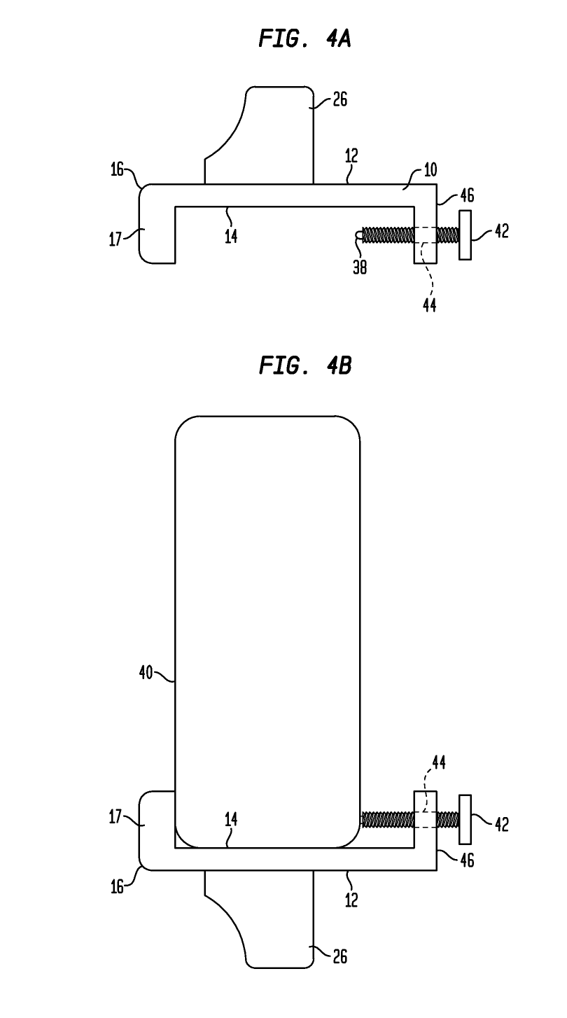

As illustrated in FIG. 4, a viewfinder 100 is illustrated, in context, on a digital camera. The viewfinder 100 may be used on an electronic device suitable for taking digital photographs 40, including digital cameras and cellular telephones. As described herein, the viewfinder 100 may also be used on a suitable cellular telephone that includes a similar viewing screen 42. As illustrated, the viewfinder 100 is mounted perpendicular to the body of the camera, and is not disposed at an angle, i.e., the central axis A (FIG. 1) of the viewfinder 100 is parallel with the central axis of the camera lens.

During photography, there may be slight difference between the frame which is shot by the camera or cell phone, and the frame seen through the viewfinder. The difference is referred to as parallax error. Parallax is an apparent difference or displacement in the position of an object when viewed along two different lines of sight. The difference or displacement is measured in terms of the angle of inclination (or declination) between the different lines of sight. Since the viewfinder will likely be located about one inch above or to the side of the lens, one using the viewfinder will see the subject from a slightly different angle than the lens. In order to correct the error, it should be understood that one taking the photographs may need to take several photographs to identify the amount of difference, particularly when taking macro photographs. In doing so, the lines of the sighting grid may be suitably used to assist the user to correct the apparent difference. The problem does not tend to occur when taking long-range photographs, as the difference is almost unnoticeable at long distances.

Advantageously, the removably mountable viewfinder 100 according to the invention is easy to place on a camera or cell phone, is easy to carry as it takes up minimal space, is inexpensive and easy to manufacture, and helps one in taking digital photographs, particularly in brightly-lit areas. For example, a user may direct a viewfinder disposed on a suitable electronic device toward an image, including a person, a landscape, or an object. Using the lines of the grid as a guide, one may take a photograph without having to look at the LCD or other type of viewing screen. As a further advantage, by using the viewfinder, one can steady the camera or cellular phone by bracing it against or close to the face, making the camera or phone less prone to shake.

FIG. 4A illustrates a side view of a second embodiment of the viewfinder in accordance with the principles of the invention. In this illustrated embodiment, base member 10 includes a first end 16 and a second end 46 extending downward from the base member 10. Through second end 46 is a hole or slot 44, through which screw 42 may be inserted. The slot or hole 44 may be threaded in order to retain screw 42 in place. A rubber or plastic nub 38 may be positioned at an end of screw 42 to provide a cushion in position screw 42 against an electronic device.

FIG. 4B illustrates a side view of the second embodiment of the viewfinder disposed on electronic device 40. In this illustrative embodiment, the viewfinder is positioned on a bottom surface of the electronic device 40. That is the bottom surface 14 of base member 10 is position against a bottom surface of electron device 40. The screw 42 may be tightened against the body of electronic device 40 in order to retain the housing 26 (and the viewfinder configuration) firmly to the electronic device 40.

Although the viewfinder of FIG. 4B is shown attached to a bottom surface of the electronic device 40, it would be recognized that the housing 26 may also be attached to the top surface of the electronic device without altering the scope of the invention claimed.

FIG. 4C illustrates a side view of a third embodiment of the viewfinder claimed, wherein the viewfinder 26 is positioned above electronic device 40. In this illustrated example, first end 16 of base member 10 extends substantially perpendicular along a back surface of electronic device 10. The extension of first end 16, represented as extended leg 49, positions viewfinder 26 above a top surface of electronic device 40. In addition, base member 10 may include a hole or slot 47, which enables a conventional screw mounting (not shown) to engage a conventional internal thread within the electronic device 40. The screw mounting may be used to attach the electronic device 40 to a tripod type device to stabilize the electronic device 40.

Also illustrated is leg 51 extending substantially perpendicular to extended leg 49 in which housing 26 is retained. Leg 51 may be positioned substantially perpendicular to extended leg 49 or may be positioned at a slight tilt angle in order to orient housing 26 at a slight angle of declination. In addition, leg 51 may be attached to extended leg 49 by a rotational means 57 that may adjust leg 51 at a slight angle of declination (or elevation). The angle of declination may be adjusted to avoid or minimize a parallax error that may be introduced by the different angles of observation between the housing 26 and the optical axis of the electronic device. In addition, rotational means 57 may be set at a fixed angle (e.g., one or two degree declination) with respect to the optical axis of the electronic device 40. In this case, the angle of declination may be preset with regard to leg 51 and extended leg 49.

FIG. 4D illustrates a front view of an electronic device 40, incorporating the viewfinder configuration shown in FIG. 4C. In this illustrative example, electronic device 40 is represented as a pocket camera including a lens mechanism 53. The base member 10 is attached to a bottom surface of the electronic device 40 and the second leg 46 extends upward from base member 10 to engage a front surface of electronic device 40. Also illustrated is screw member 42 that is used to retain the viewfinder firmly to the electronic device 40.

FIG. 4E illustrates a back view of an electronic device 40 incorporating the viewfinder configuration shown in FIG. 4C. In this illustrative embodiment, the electronic device 40 includes a viewing screen (e.g., an LCD display) 55, through which a user may view an image to be taken and an image that has been taken. Extended leg 49 extends along the back of the electronic device 40 to position housing 26 above the electronic device 40, as previously described. In addition, extended leg 49 may be constructed as a frame 59 that substantially allows the LCD display 55 to be viewed through the viewfinder assembly. That is, extended leg 49 is preferable constructed as a frame that substantially surrounds the LCD screen of electronic device 40.

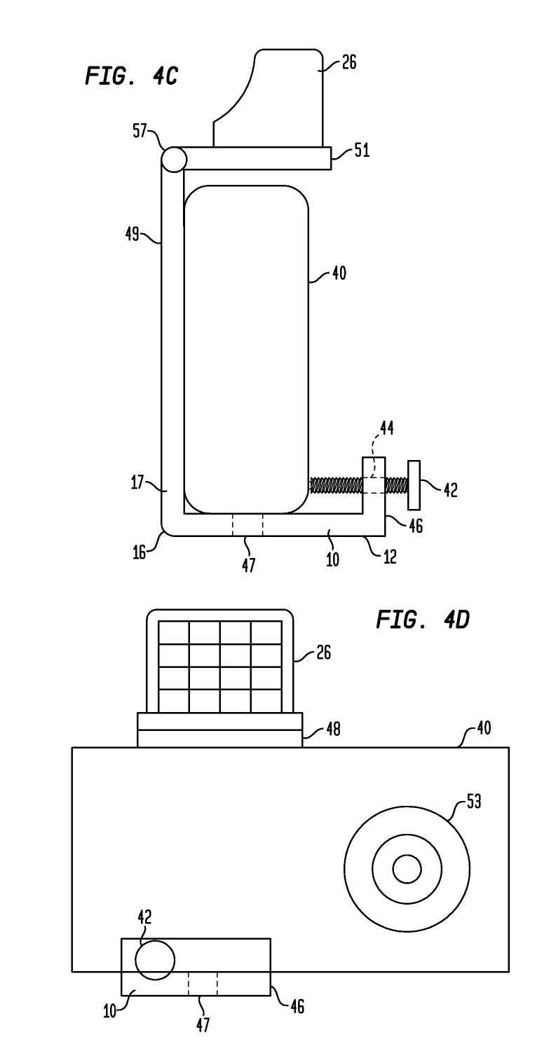

FIG. 5 illustrates a front view of a viewfinder 500 in accordance with another embodiment of the invention. In this exemplary embodiment, disposed on a stem 525 is housing 510. The housing 510 is open at both ends, and is substantially rectangular. Within an open end of the housing 510 is disposed a sighting grid 520, similar to that shown in FIG. 1. The sighting grid 520 may be composed of thin wires (e.g., steel, aluminum, nylon fiber, etc.).

The sighting grid 520 may include one or more horizontal lines 522 intersecting with one or more vertical lines 524. The sighting grid 520 may be used to center a subject or to use as a guide in preventing parallax error, as herein described. Although the sighting grid 520 is described as including one or more horizontal lines intersecting with one or more vertical lines, it should be understood that different orientations for the sighting grid 520 are possible. For example, the lines may intersect to form triangles, parallelograms, and other geometrical shapes.

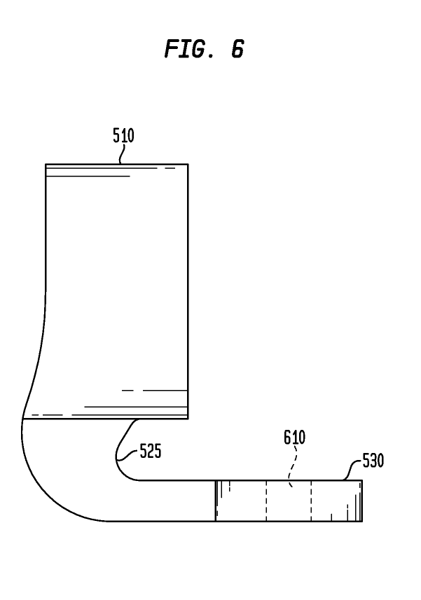

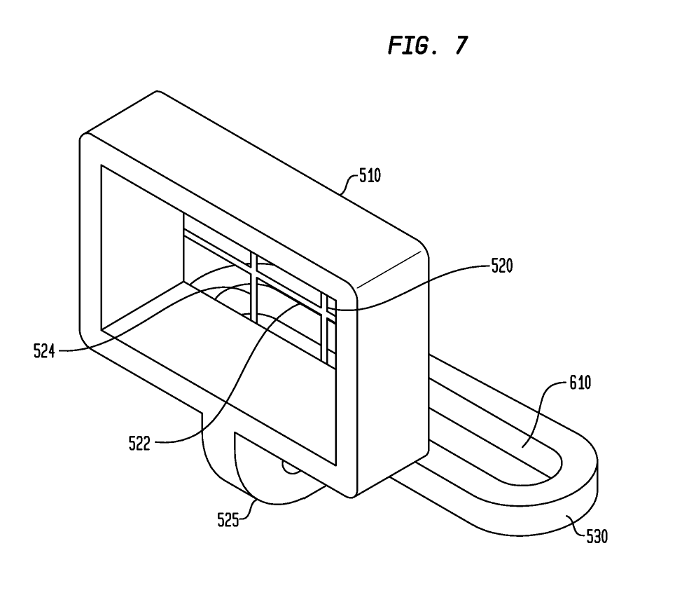

Stem 525 extends from, and in a plane of, mounting plate 530 (i.e., base member 10) which is positioned substantially parallel to housing 520. Mounting plate 530 may be used as described with regard to FIGS. 8 and 9 may be used to position and retain the viewfinder 500 substantially stationary with regard to a camera or similar photographic equipment.

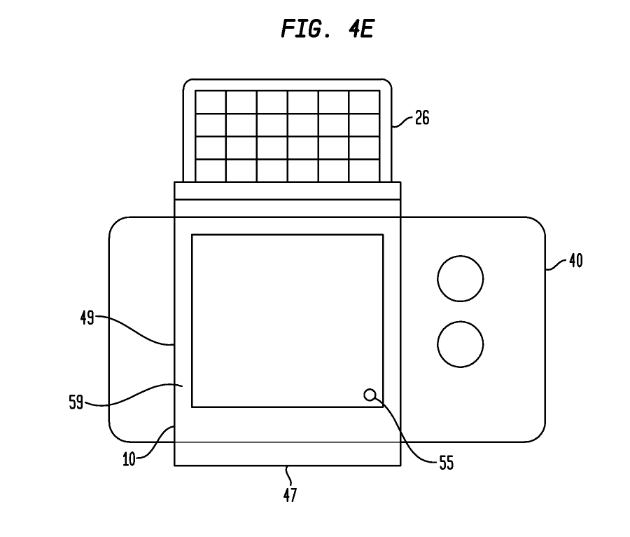

FIG. 6 illustrates a side view of the viewfinder shown in FIG. 5. In this illustrated exemplary embodiment, stem 525 is offset, and extends substantially perpendicular, from mounting plate 530. Housing 510 which includes grid 520 (not shown) is substantially parallel to mounting plate 630. Extending from a top surface to a bottom surface of mounting plate 530 is slot 610, through which an attachment means may be used to retain the housing 510 substantially fixed with regard to a camera body (not shown). Slot 610 may represent one continuous slot through which an attachment means may be inserted. In addition, slot 610 may represent at least one hole through which an attachment means may be inserted. The at least one hole may be threaded in order to retain the attachment means.

Although housing 510 is shown in a relatively fixed position with regard to a plane of mounting plate 530, it would be recognized that housing 510 may be attached to stem 525 with a rotatable means wherein the housing maybe tilted in a downward or upward direction, in a manner similar to that shown in FIG. 4C.

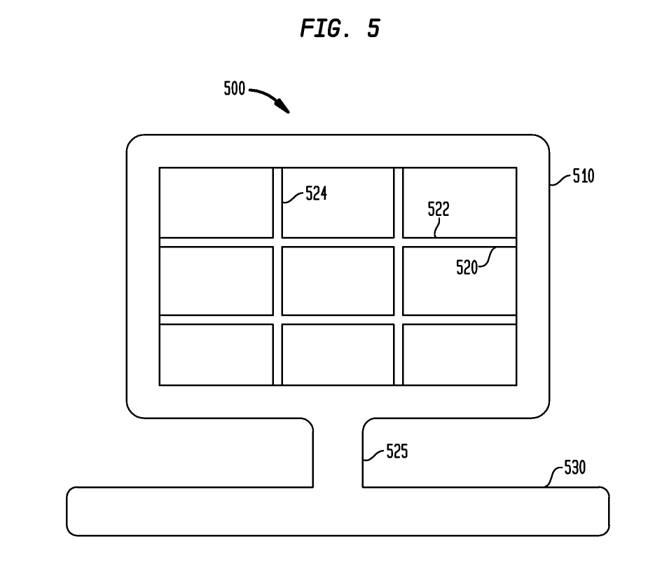

FIG. 7 illustrates a prospective view of the viewfinder 500 shown in FIG. 5. In this illustrative exemplary embodiment, slot 610 is shown extending substantially from one end of mounting plate 530 to another end of mounting plate 530.

FIG. 8 illustrates a second side view of the viewfinder shown in FIG. 5 and further attached to a camera body 810. In this illustrative example, attachment means 820 extends through mounting plate 530 through slot 610 to attach to a known connection point within camera body 810. For example, camera body 810 may include an internal type connection point that allows attachment means 820 to connect external devices (e.g., viewfinder 500) to the camera body. In a conventional camera body, the internal type connection point may represent an internal screw mechanism into which an external screw thread may be inserted. The attachment of an external screw tread into the internal screw thread retains the viewfinder 500 substantially fixed with regard to the orientation of the camera body 810. In addition, the attachment means 820 may include an internal type thread mechanism 821. The internal type thread mechanism 821 within attachment means 820 provides for an attachment of the electronic device 810 to a tripod type device (not shown) through a second screw to stabilize the electronic device.

Although viewfinder 500 is retained in a substantially fixed position, with regard to camera body would be appreciated that housing 510 may be tilted in an upward or downward direction in order to overcome any issues with regard to parallax. As would be recognized, the tilt of housing 510 may be obtained by having the stem 525 orient the housing 510 in downward orientation with respect to a plane of the mounting plate 530. Alternatively, housing 510 may be attached to stem 525 by a rotational means that allows housing 510 to be oriented at a desired angle (upward, downward) with respect to a plane of the mounting plate 530.

FIG. 9 illustrates a prospective view of the viewfinder shown in FIG. 5, which illustrates the attachment means being positioned offset from the center of the camera body 810. Hence, the use of slot 610 in mounting plate 530 is advantageous in that it allows viewfinder 500 to be positioned substantially in-line with the optical axis (not shown) of camera body 810. In one aspect of the invention, the optical axis of the viewfinder may be positioned at a slight angle to the optical axis of the camera body 810. The positioning of the optical axis of the viewfinder with respect to the optical axis of the camera body 810 provides for the reduction of a parallax effect between the position of the lens (optical axis of the camera body) and the viewfinder.

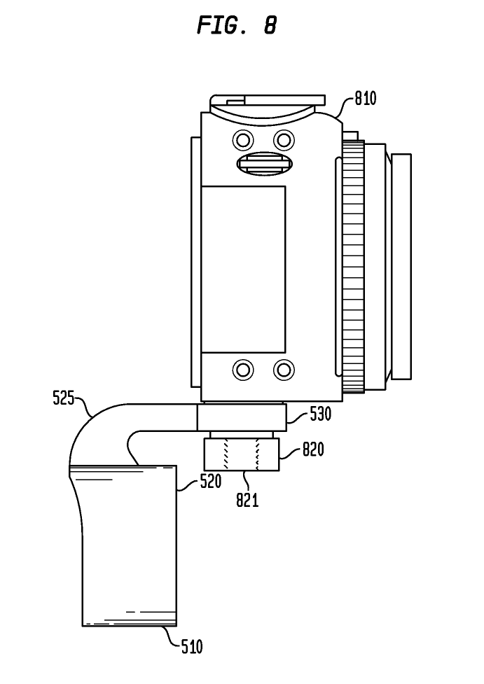

FIG. 10 illustrates a front view of still another embodiment of the viewfinder 1000 in accordance with the principles of the invention. In this illustrative embodiment, housing 510 and mounting plate 530 are as previously described and the description of these elements need not be repeated again.

Also, illustrated is frame 1010 surrounding an open area 1020. Extending from fame 1010 is stem 1015, which supports housing 510 substantially perpendicular to frame 1010.

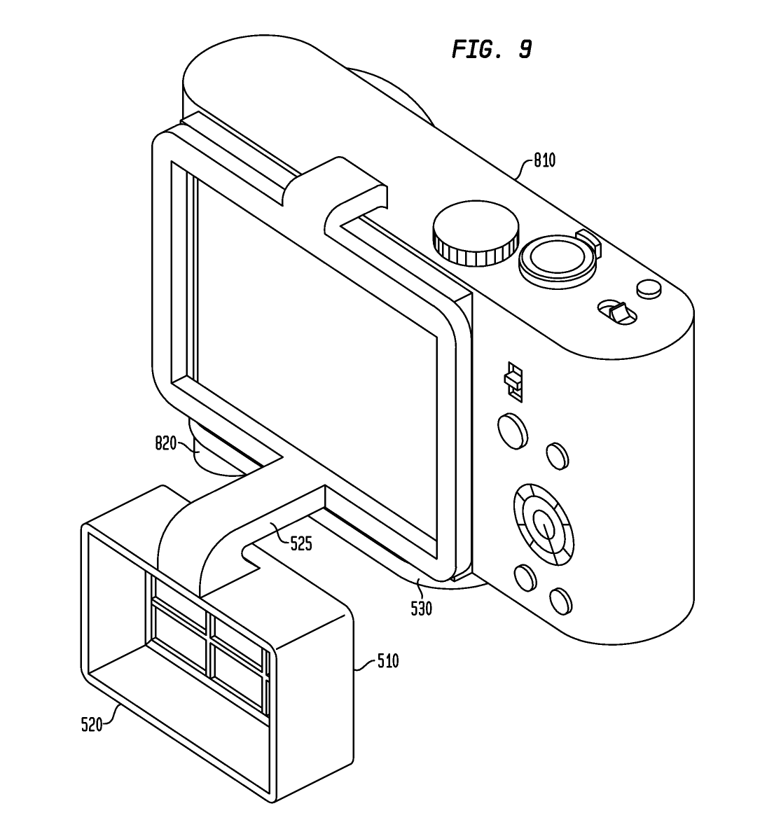

FIG. 11 illustrates a prospective view of the viewfinder 1000 shown in FIG. 10. In this illustrative embodiment, frame 1010 is offset from, and connected to stem 525, in a manner similar to that described previously. Frame 1010 creates therein a viewing window 1020. Stem 1015 maintains housing 510 substantially perpendicular to, and offset from, with respect to a plane of the mounting plate 530. As previously described viewfinder 1000 is retained substantially fixed with regard to a camera body (not shown) by inserting an attachment means (not shown) through slot 610. In this illustrative example, slot 610 is shown extending substantially from one end of mounting plate 530 to another end of mounting plate 530. In addition, housing 510 may be tilted upward or downward through a rotation member attachment between stem 1015 and housing 510. This rotation member may, for example, be a friction member in which friction retains housing 510 in a desired position.

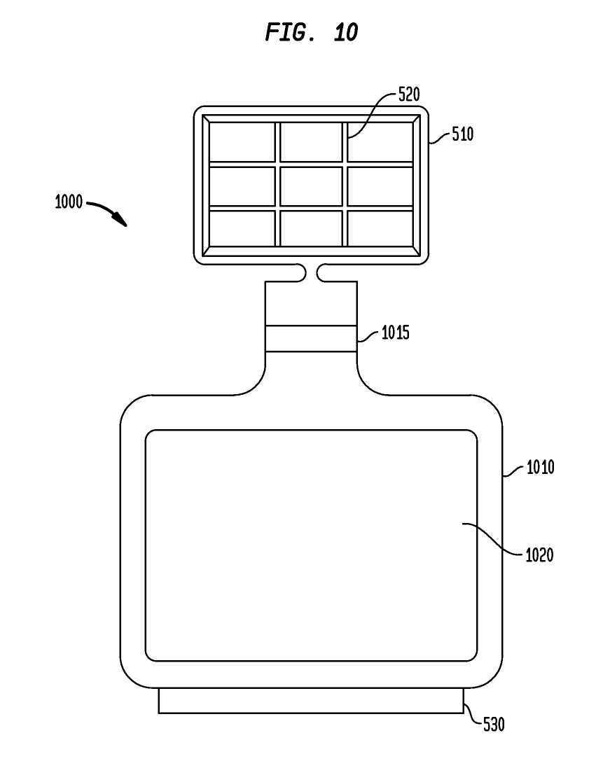

FIG. 12 illustrates a prospective view of viewfinder 1000 attached to a camera body 810 through attachment means 820. The attachment of viewfinder 1000 is similar to that of viewfinder 500 and need not be discussed again herein.

Also illustrated is viewing window 1020 being positioned in such a manner that a LED display window 1220 is viewable through frame 1010. The ability to view LED display window 1220 through frame 1010 is advantageous as it allows a user to maintain the viewfinder 1000 in place while being able to review images taken by camera 810.

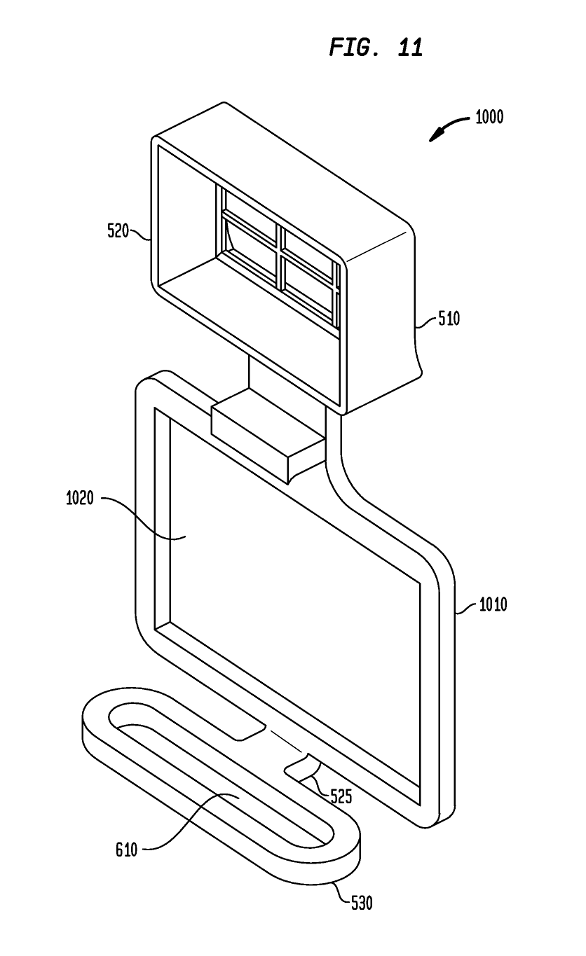

FIG. 13 illustrates a side view of the viewfinder 1000 shown in FIG. 10. As shown, frame 1010 extends substantially perpendicular to mounting plate 530. In addition, stem 1015, extending from frame 1010, retains housing 510 is a substantially fixed position with regard to mounting plate 530. In one aspect of the invention, which is shown in FIG. 13, stem 1015 is oriented to provide a slight downward tilt to housing 510. In another aspect of the invention, stem 1015 may retain housing 510 in a substantially parallel position with respect to mounting plate 530 and a rotational means may be used to orient housing 510 slightly upward and/or downward. The rotational means may be frictional, for example. In addition, the rotational means may be calibrated in order to tilt the housing by a known amount based on an actual or estimated distance to remove any parallax effect. For example, the housing 510 may be positioned at a zero degree orientation (with respect to the plane of mounting plate 530), when the object to be photographed is relatively far away and may be adjusted downward by one or two degrees as the distance between the camera and the object to be photographed is closer to the camera.

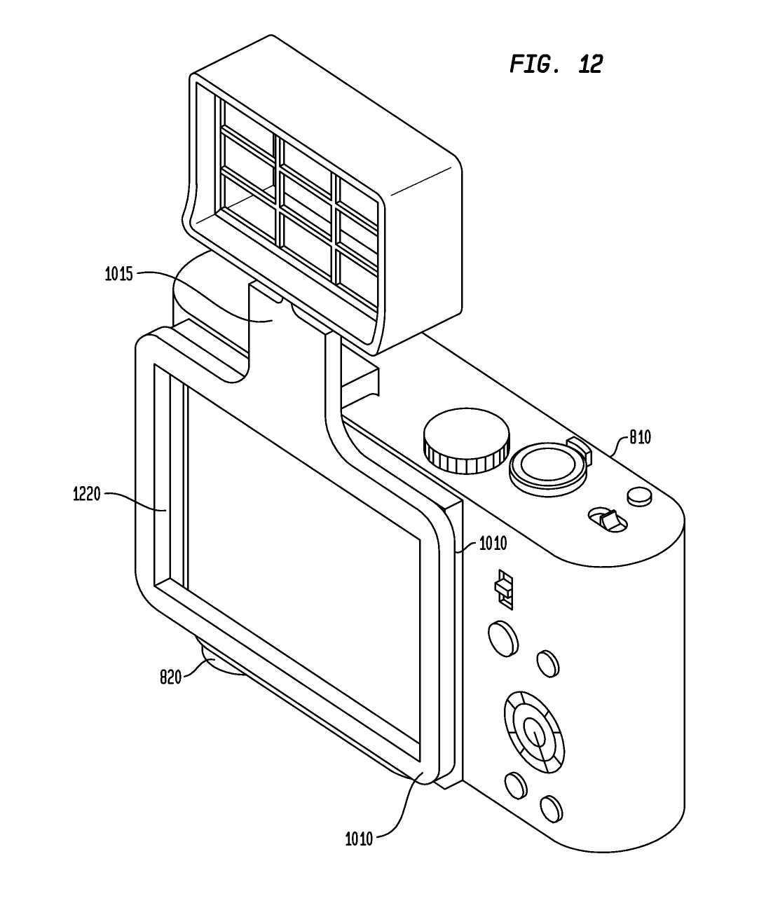

FIG. 14 illustrates a second side view of the viewfinder 1000 shown in FIG. 10. In this illustrated side view, viewfinder 1000 is attached to camera 810 by attachment means 820, as previously described. The frame 1010 is offset from the camera body 810 and attaches housing 510 above camera body 810. In this illustrative example, the viewfinder 1000 operates in a manner similar to a conventional viewfinder found on conventional single lens reflex cameras, wherein the user may view an object through the view finder housing 510 in order to capture an image. In addition, the user may view the captured image through the window 1020 within frame 1010, as previously described. In this illustrative embodiment, stem 1015 is substantially parallel to the mounting plate 530.

The invention has been described with reference to specific embodiments. One of ordinary skill in the art, however, appreciates that various modifications and changes can be made without departing from the scope of the invention as set forth in the claims. For example, the sighting grid is described without a lens, although a suitable lens may also be disposed in the housing of the viewfinder according to an aspect of the invention. In addition, other means of attachment, whether permanent or by other conventional removable mechanisms may also be used. In addition, while the viewfinder device described herein is described with regard to a camera (e.g., a point and shoot type), it would be recognized that the viewfinder device may also be attached to a cellular telephone (e.g., a smart phone) or similar devices (e.g., tablet PC), without altering the scope of the invention. For example, in one aspect of the invention, the viewfinder described herein may include a friction type mounting bracket that enables the viewfinder to be attached to a cellular telephone. For example, the viewfinder mounting bracket may be shaped similar to a corresponding electronic device (camera or cell phone) and the means for attaching the mounting bracket to the electronic device 40 may include tabs that attach to, and hold, the corners of the electronic device 40 by friction. In this case, the housing may be slidably connected to the mounting bracket in order to extend the housing and the sighting grid from, or retract the housing and sighting grid into, the mounting bracket.

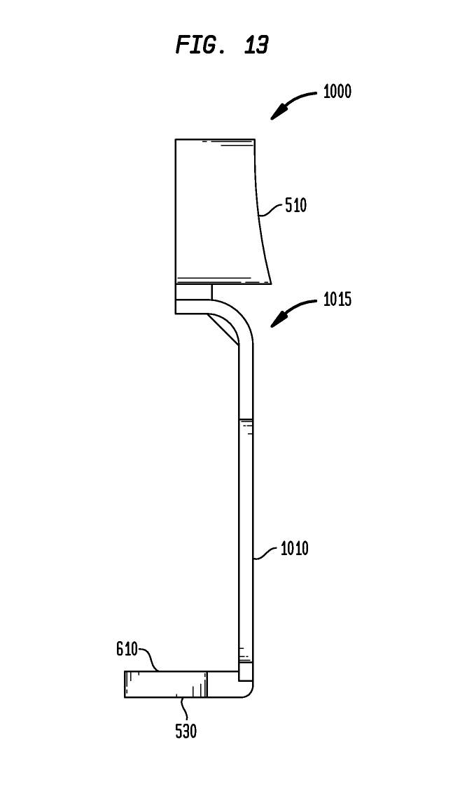

FIG. 15 illustrates a prospective view of a friction-type mounting bracket 1500 suitable for providing a viewfinder capability to a cellular (smart) phone. In this illustrated example, a case 1505, includes an opening 1520 into which a cellular or smart phone may be inserted. The smart or cellular phone is held in place within mounting bracket 1500 by a lip 1510 extending around an outer edge (perimeter) of the mounting bracket 1500 opening. In this illustrated example, a touch-screen face of the smart phone (not shown) is directed outward from the plane of the paper so that a user may operate one or more functions or operations associated with the cellular phone. One such operation may be a camera function. The mounting bracket 1500 may be constructed of a plastic or a metal frame.

Opening 1550 in a back surface of the mounting bracket 1500 may be used to allow a camera lens access to an external environment. Housing 1530 may extend from a back surface of the mounting bracket 1500 when desired. The housing 1530 may be retracted into opening 1560 when not in use. Housing 1530 is similar to housing 26 shown in FIG. 1, for example, and a full description of which need not be repeated again, herein. Housing 1530 includes a sighting grid, which in one aspect of the invention may be composed of a grid of horizontal and vertical steel lines, as previously described.

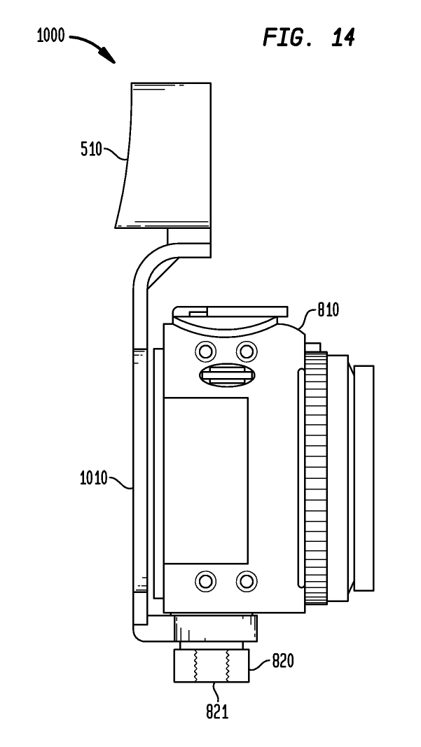

FIG. 16 illustrates a second prospective view of the mounting bracket 1500 shown in FIG. 15. In this second prospective view (which illustrates a back (second) surface of mounting bracket 1500), lens 1640 of an enclosed smart phone may be positioned within opening 1550. The positioning of lens 1640 in opening 1550 allows the smart phone to capture images through lens 1640. Also shown is housing 1530 slidably extending from opening 1560. In this position, the housing 1530 may be used to align an object (using the illustrated sighting grid) prior to capture an image of the object using a camera function of the smart phone.

In this illustrated example, housing 1530 may extend from or be retained in opening 1560. Slidably engaging the housing 1530 into a back surface of mounting bracket 1500 is advantageous as it allows the housing 1530 and the viewfinder sighting means to be usable in cases when viewing an object to be photographed when using the touch surface of the smart phone is difficult and also places the housing 1530 out of sight when not needed.

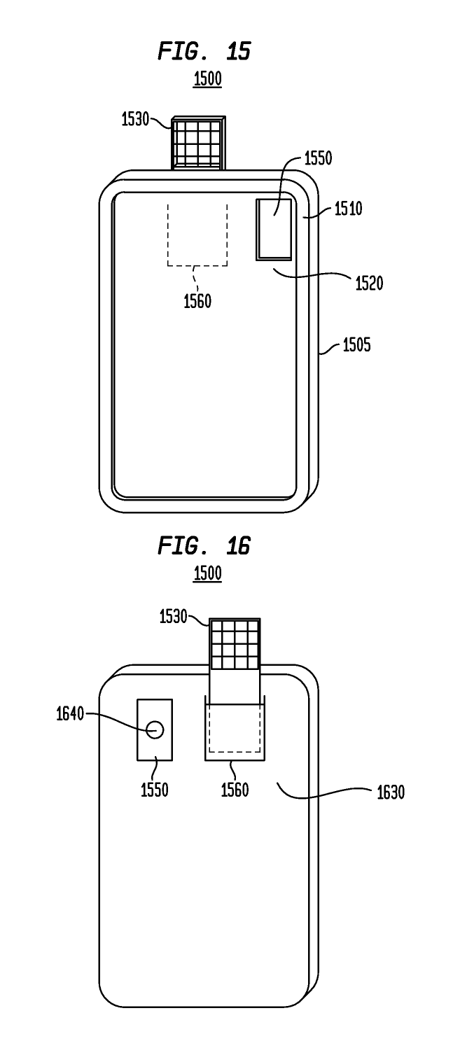

FIG. 17 illustrates a side view of an exemplary mounting bracket 1500 including housing 1530 in accordance with the principles of the invention. In this illustrated example, an electronic device (e.g., smart phone) 40 is held in place by tabs or lips 1520. The housing 1530 slidably extends from the back surface of the mounting bracket 1500, when desired. Housing 1530 may also be retracted into opening 1560 when the housing 1530 is no longer required.

Although the viewfinder shown in FIGS. 15-17 is shown to attach to an electronic device 40 in a substantially vertical position wherein the housing 1530 extends in a direction parallel to the vertical axis. However, it would be recognized by those skilled in the art, that the housing 1530 may be oriented with regard to case 1505 so that the housing 1530 extends in a direction perpendicular to the vertical axis. In this case, the housing 1530 and sighting grid may be comfortably used when the electronic device 40 is held in a horizontal position.

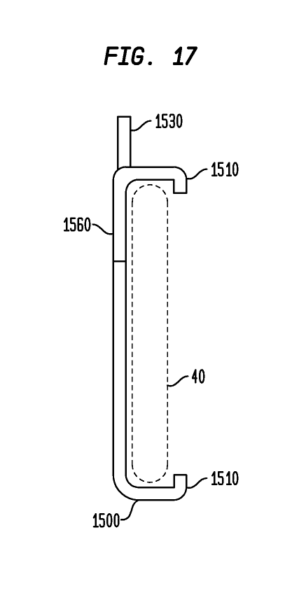

FIG. 18 illustrates another embodiment of the viewfinder 1800 in accordance with the principles of the invention. In this exemplary embodiment, the viewfinder 1800 comprises a base member 1810 and a housing 1820. The housing 1820, includes a sighting grid 1835, and is similar to the housing 1530 shown in FIG. 15, for example. Housing 1820 extends from base member 1810 by a stem 1830. As the housing 1820 is similar to previously described housing 26, FIG. 1, or housing 1530, FIG. 15, a detailed description of the housing and sighting grid 1835 need not be repeated again herein.

Base member 1810 is shaped to include lip 1840 at a top end and lip 1842 at a bottom end of 1810. Lips 1840 and 1842 provide a means to attach to and hold in place an electronic device 40 in a manner similar to that shown in FIG. 15, for example. In one example, an electronic device 40 may be slide between lips 1840 and 1842. In another example, an electronic device 40 may be snapped into place between lips 1840 and 1842. Base member 1810 and lips 1840, 1842 are sized to accommodate a plurality of electronic devices. For example, base member 1810 may be sized to hold the electronic device 40 in a horizontal direction or many be sized to a vertical direction. In another aspect of the invention, the base member 1810 may be constructed on a lower part and an upper part that slidably engage one another so that the base member maybe sized to hold an electronic device in either a vertical or a horizontal direction.

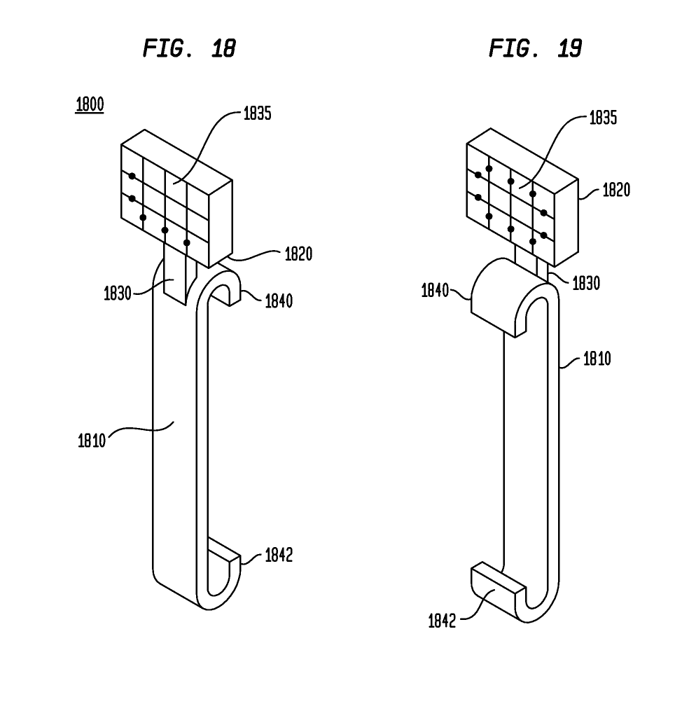

FIG. 19 illustrates a second prospective view of the viewfinder 1800 shown in FIG. 18. FIG. 19 illustrates the lips 1840, 1842 as U-shaped flanges used to engage the edges of an electronic device. In exemplary embodiments of the invention, the size of the lips is determined based on a thickness of a corresponding electronic device.

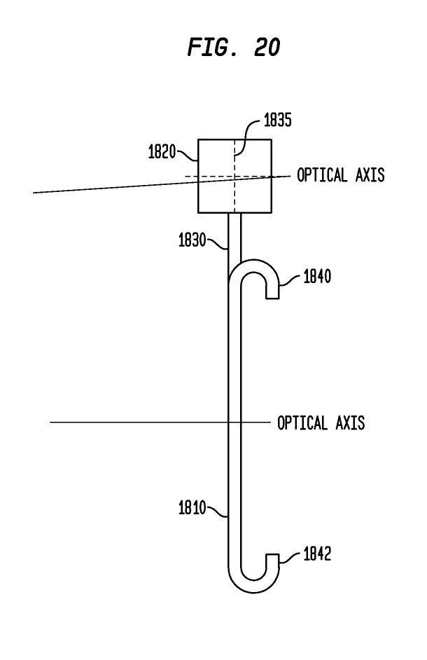

FIG. 20 illustrates a side view of the viewfinder shown in FIG. 18. In this, housing 1820 attaches to stem 1830 which extends from the base member 1810. In this illustrated case, the optical axis of housing 1820 is oriented at a slight angle with respect to an axis line perpendicular to base member 1810. As previously discussed, the orientation of the optical axis of the housing 1820 at a slight angle with respect to an optical axis of an electronic device held in place by base member 1810 is advantageous in reducing any parallax error that may be introduced by the offset of housing 1810 with respect to the optical axis of electronic device 40.

In one aspect of the invention, the viewfinder 1800 may include an adjustable clip that provides for retaining the base member 1810 onto the electronic device. In this aspect of the invention, the base member 1810 may include a clip member at a lower end and a lip (similar to that shown in FIG. 18) at an upper end. The clip may be used to retain the base member 1810 onto the electronic device.

The specification is to be regarded in an illustrative manner, rather than with a restrictive view, and all such modifications are intended to be included within the scope of the invention.

Benefits, other advantages, and solutions to problems have been described above with regard to specific embodiments. The benefits, advantages, and solutions to problems, and any element(s) that may cause any benefits, advantages, or solutions to occur or become more pronounced, are not to be construed as a critical, required, or an essential feature or element of any or all of the claims.

1. A viewfinder, comprising:
a mounting plate for removably mounting said viewfinder onto an electronic device suitable for taking digital photographs;
a stem extending substantially perpendicular from said mounting plate;
an open-ended housing disposed on stem, wherein said stem offsets said open-ended housing from said mounting plate; and
a sighting grid disposed adjacent an open end of said open-ended housing.

2. The viewfinder according to claim 1, wherein said mounting plate further comprises:
at least one hole extending from a top surface to the mounting plate to a bottom surface of the mounting plate.

3. The viewfinder according to claim 2, wherein said at least one hole is a slot extending substantially from one end of the mounting plate to another end of the mounting plate.

4. The viewfinder according to claim 1, further comprising:
a rotational means attaching said housing to said stem, wherein said rotational means causes said housing to be tilted upward and downward.

5. The viewfinder according to claim 2, wherein stem attaches said housing at a known angle relative to a plane of said mounting plate.

6. The viewfinder according to claim 5, wherein said known angle is between zero and two degrees with respect of the plane of said mounting plate.

7. The viewfinder according to claim 1, wherein said sighting grid comprises one or more horizontal lines intersecting with one or more vertical lines.

8. The viewfinder according to claim 1, wherein said electronic device is a digital camera.

9. The viewfinder according to claim 1, wherein said electronic device is a cellular telephone.

10. The viewfinder according to claim 1, further comprising:
a frame positioned between said stem and said mounting plate, said frame containing a viewing window therein.

11. The viewfinder according to claim 11, further comprising:
a second stem, extending substantially perpendicular to said mounting plate, and causing the frame to be offset from said mounting plate.

12. A viewfinder for removably mounting onto an electronic device suitable for taking digital photographs, comprising:
a substantially flat mounting means comprising:
a slot extending from a top surface to a bottom surface of the mounting means;
a stem portion attached to the mounting means, said stem portion extending at one end from said mounting means;
a housing disposed on a second end of said stem, said housing including a sighting grid, wherein said stem positions the housing substantially perpendicular to, and offset from, a plane of the mounting means.

13. The viewfinder according to claim 12, wherein said housing is attached to said stem by at least one of a: a fixed means and a rotational means.

14. The viewfinder according to claim 12, wherein said sighting grid comprises one or more horizontal lines intersecting with one or more vertical lines.

15. The viewfinder according to claim 13, wherein the fixed means orients the housing at a known angle with respect to the plane of the mounting means.

16. A viewfinder comprising:
a mounting plate;
a stem attached to, and extending outward in a plane of the mounting plate;
a frame extending from said first stem, said stem positioning the frame substantially perpendicular to, and offset from, a plane of the mounting plate, said frame including a viewing window therein;
a housing, including a sighting grid therein, extending from said frame, said housing being positioned substantially perpendicular to, and offset from, a plane of said mounting plate.

17. The viewfinder according to claim 16, further comprising:
at least one hole extending from a top surface to a bottom surface of the mounting plate.

18. A viewfinder comprising:
a mounting bracket comprising:
a first surface having an opening; and
a lip extending around a perimeter of the opening; and
a second surface having a first slot, said first slot including a slidably engageable housing, said housing comprising a sighting grid.

19. A viewfinder comprising:
a mounting bracket having a U-shape flange at each of a first end and a second end; and
a stem extending substantially perpendicular from said mounting plate;
an open-ended housing disposed on the stem, wherein said stem offsets said open-ended housing from said mounting bracket; and
a sighting grid disposed adjacent an open end of said open-ended housing.

20. The viewfinder according to claim 19, further comprising:
a rotational means attaching said housing to said stem, wherein said rotational means causes said housing to be tilted upward and downward.

21. The viewfinder according to claim 19, wherein the stem attaches said housing at a known angle relative to a plane perpendicular to said mounting bracket.

22. The viewfinder according to claim 12, wherein said known angle is between zero and two degrees with respect of the plane perpendicular to said mounting bracket.

23. The viewfinder according to claim 19, wherein said sighting grid comprises one or more horizontal lines intersecting with one or more vertical lines.
